(19) United States
(12) Patent Application Publication
(10) Pub. No.: US 2006/0039263 A1
(43) Pub. Date: Feb. 23, 2006

(54) Audio system with removable digital media player

(76) Inventor: Remy Trotabas, Bartlett, IL (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/922,672

(22) Filed: Aug. 20, 2004

(51) Int. Cl. G11B 3/74

(52) U.S. Cl. 369/86; 369/30.01

(57) ABSTRACT

An audio system with a removable digital media player is presented. The invention comprises a base unit that can receive encoded audio signals, output audio signals to a speaker or other audio output device, and interface with a removable digital media player. The digital media player interface may have the ability to receive signals from and output signals to the removable digital media player, and can also charge the battery of the digital media player. The base unit may also contain a memory for buffering and storing output signals from the digital media player or other audio input data. The base unit may also provide advanced playback options of stored audio inputs, including the ability to pause, rewind, record, and replay live audio inputs. Additionally, the base unit of the system may include a removable faceplate.

### FIELD

The present invention relates to the field of audio systems and, more specifically, to audio systems with removable digital media players.

### BACKGROUND

Home and automobile audio systems generally use compact disc technology to provide portable high-quality recorded audio. Compact discs, which are the media utilized to store the audio data for this technology, are only capable of storing approximately eighty minutes of music per disc. As a result, users of this technology generally keep a large number of compact discs at hand to provide easy access to a diverse music collection. The compilation of a large number of compact discs can become problematic in areas where space is limited, such as an automobile.

Recently portable digital music players have been introduced that have large data storage capability. The large memories found in many of these devices, coupled with advanced data compression techniques, allow some portable digital music players to store the equivalent number of hours of music as approximately 500 compact discs. Given their relatively small size, the data density of current portable digital music players is shown to be several orders larger than compact discs, and is a more conducive method of audio storage for enclosed spaces.

Safety laws generally prohibit a person from engaging in activities that directly impair their sense of hearing while driving an automobile, thereby preventing a driver from enjoying the benefits of portable music player through the use of headphones. However, a driver is generally legally able to utilize the built-in sound system of an automobile in order to enjoy music while driving.

In the past, specialized adapter kits have been utilized which convert the analog outputs of portable music devices to a form that can be read by the audio receiver system of automobiles. Generally, these adapter kits utilized either the magnetic cassette tape reader or the radio receiving antenna as an interface between the digital audio source and the audio receiver. Despite its relative convenience, the use of either the magnetic heads or the radio receiving antenna to transmit audio data often resulted in a sound output that was of substantially poorer quality than the actual source data.

It would be desirable to permit owners of portable digital media players to directly access audio data stored in their digital media players with their car audio system or home audio system. Such audio system architecture could help mitigate the logistical problems associated with keeping a large audio library on hand, and help to eliminate the need to store large amounts of voluminous compact discs. This method would also preserve the digital sound quality provided by the high-density digital media player memory. Additionally, it is desirable to have an interface between the portable digital media player and the base audio system that permits for the simple introduction and removal of the portable device. The user should be able to physically connect and disconnect the portable music player with such ease as to permit the user to maintain a focus on other activities, such as driving.

### BRIEF DESCRIPTION OF THE DRAWINGS

Preferred embodiments are described below in conjunction with the drawing figures, wherein like reference numerals refer to like elements in the various figures, and wherein:

FIG. 1 is a schematic of an audio system with a digital media player connecting to a base unit through an opening in a front face of the base unit, according to an embodiment.

FIG. 2 is a schematic of a base unit with a resident CD player, according to an embodiment.

FIG. 3 is a schematic of an audio system with a digital media player connecting to the base unit through an opening in the front face of the base unit, according to an embodiment. The base unit has a faceplate, which is shown open. The digital media player is partially inserted in the base unit.

FIG. 4 is a schematic of an audio system with a digital media player connecting to the base unit through an opening in the front face of the base unit, according to an embodiment. The digital media player is fully inserted into the unit and the base unit faceplate is shown closed.

FIG. 5 is a schematic of the base unit of the audio system without the digital media player, according to an embodiment.

FIG. 6 is a flow diagram illustrating a process for using the audio system as a digital radio recorder, according to an embodiment.

### DETAILED DESCRIPTION

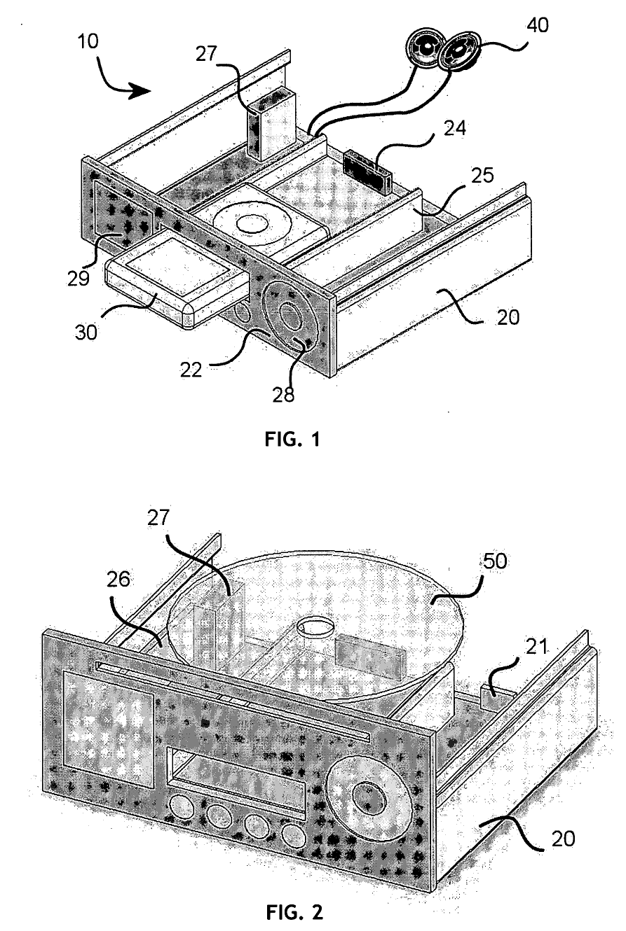

FIG. 1 shows an audio system 10 that has a base unit 20 with an internal active audio processing unit 27, which may include an amplifier, a digital signal processor, and a microprocessor for performing advanced computational functions. The audio processing unit 27 also provides an audio output signal to an audio speaker 40. A portable and removable digital media player 30 is shown in the process of being inserted into an internal bay located inside the base unit 20.

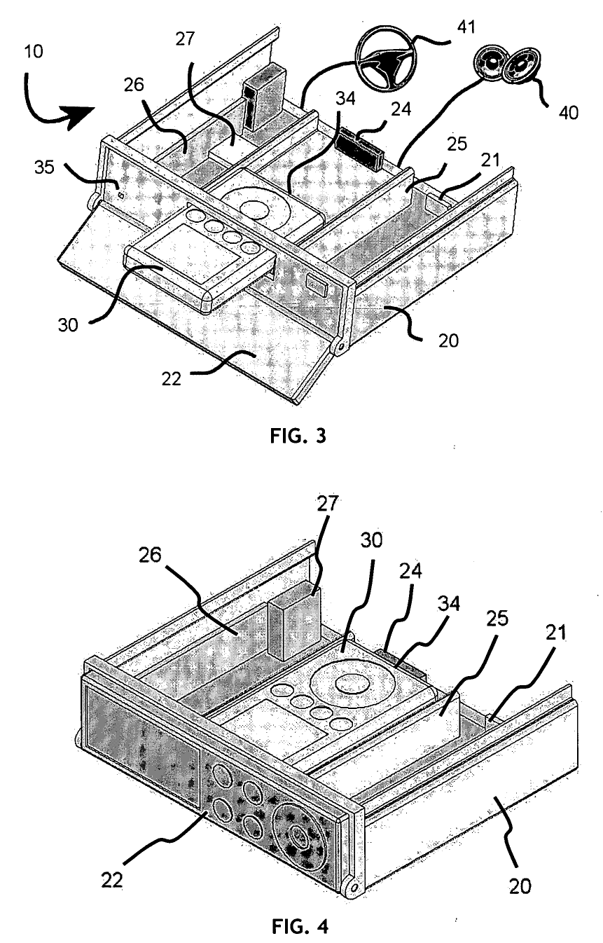

The base unit 20 is similar to such devices as a car audio system or a home audio system. The audio processing unit 27 may have audio inputs originating from devices resident in the base unit, such as a CD player 50 as depicted in FIG. 2, a cassette player, a DVD player, a solid state memory port, a navigation system, or a tuner (such as an AM tuner, an FM tuner, a satellite radio tuner, or combination thereof.) Additionally, the audio processing unit 27 may receive input from external audio input sources such as a satellite radio processing unit, an external CD changer, a cellular phone or a microphone 35 (FIG. 3). The base unit 20 may have access ports to these external input devices.

The digital media player 30 may be capable of operating as a standalone active device. A power source, such as rechargeable batteries, may provide power to the digital media player 30. The digital media player 30 may have a memory to store digital data, particularly encoded data representative of audio signals such as MP3 (Moving Pictures Expert Group-1 Audio Layer 3), AAC (Advanced Audio Coding), or any similar digital audio encoding format or combination thereof.

The user may download songs into the digital media player 30 through the digital media player connector 34 or through wireless data transmissions from a host source of songs, such as a personal computer, other computing device, or a network connection to a remote music server. In one example, the user may set the digital media player 30 into a cradle attached to a personal computer and connect through the digital media player connector 34 to the personal computer.

The digital media player 30 may have at least one interface that has power contacts used to recharge the power source of the portable digital media player 30. Additionally, the digital media player 30 may have an interface comprising signal contacts to permit the transmission of digital or analog signals to and from an outside source. The signal contacts and power contacts may comprise separate interfaces or may be components of a single interface.

When disconnected from the base unit 20, the digital media player 30 can be operated as a standalone active music player. In addition to the music playback capability, the digital media player 30 may have additional functionalities such as, but not limited to, an organizer, a cellular phone and a digital camera.

The base unit 20 is shown with a digital media player interface 24 that allows it to interface with the digital media player 30. The slot frame 25 guides the digital media player 30 and helps it reach its designated host position in the base unit 20. In the designated host position, the digital media player connector 34 can mate with the digital media player interface 24.

Insertion of the digital media player 30 into the base unit 20 may be further assisted by an automatic transfer mechanism that detects the presence of the digital media player and moves the digital media player into host position. Similarly, the same transfer mechanism may control the ejection of the digital media player 30 out of the base unit 20.

When the digital media player 30 is in its host position in the base unit 20, the data contained in the digital media player 30 can be accessed by the audio processing unit 27 of the base unit 20 and can provide audio input to the system. This input could be in the form of an analog signal, or in a digital format representative of audio data. The data transfer between the digital media player 30 and the audio processing unit 27 could be established through a physical connection between the digital media player interface 24 and the digital media player connector 34, or through a wireless transmission between the two units.

Upon connection of the digital media player 30 to the base unit 20, the digital media player power source may be recharged through a physical connection established between the digital media player interface 24 and the power connector of the digital media player 30.

By establishing an audio transfer link between the digital media player 30 and the audio processing unit 27 of the base unit 20, the entire audio system 10 may function as a digital music jukebox and library. For example, the base unit may access the list of music files stored in the digital media player and offer a user interface on the display 29, enabling the user to navigate through the music files. Once a song is selected, it may be transferred in digital format into memory 26, decoded, amplified through the system amplifier 21, and output through one or more speakers 40. Alternatively, a selected song may be decoded by the digital media player 30, transferred in analog format to the base unit 20, amplified through the audio system amplifier 21, and output on one or more speakers 40.

The user may also be able to select which audio input will be utilized by the audio system to provide output to the speaker. The user may accomplish this through selection by the control inputs 28. The control inputs 28 may be actual buttons or knobs, or may be part of the display panel 29 that may incorporate, for example, a touch screen. The display panel 29 and control buttons 28 may provide a user interface allowing the user to receive information about the various input, output, and system parameters. Additionally, the display panel 29 may be external to the base unit 20 or have the ability to be removed from the base unit 20.

Control of the audio system 10 may also be voice-activated through the microphone 35. Alternatively, the system may be controlled through a wired control system external to the base unit 20, such as a control console located on the steering wheel 41, or through a wireless remote control system.

FIG. 3 and FIG. 4 show the audio system 10 according to an exemplary embodiment, where the control buttons 28 are located on a faceplate 22 that may flip open to enable the digital media player 30 to be inserted in frame 25 through the front face of the base unit 20.

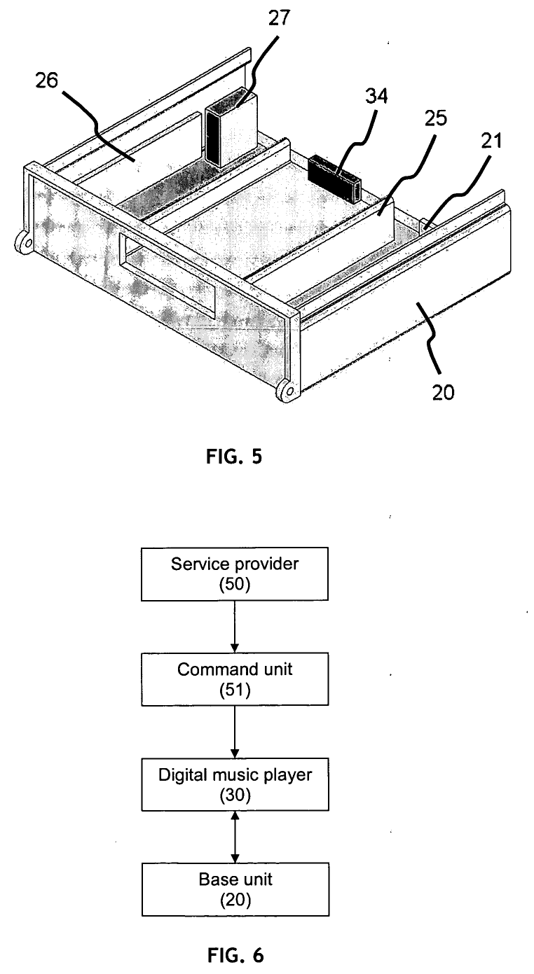

Additionally, the faceplate 22 may be removable as shown in FIG. 5. Removal of the faceplate may render the base unit 20 inoperable. This is a security feature available in current vehicular stereo systems, as an example. Typically, the user is able to release the faceplate from the base unit through pressing a button.

In addition to extracting audio data from the digital media player 30 to the base unit 20, the process may also be reversed to store audio data on the digital media player. The base unit 20 may convert audio input from one of its audio input sources such as, but not limited to, a radio tuner, a microphone or a cellular phone into a digital music format and transfer the data to the digital media player 30. Consequently, the audio system 10 may be operated as a personal audio recorder to record live radio broadcast, memos or phone conversations. The recordings would be stored in the digital media player memory 32. To enable the use as a voice recorder, the base unit 20 may incorporate a microphone 35. To enable the recording of a cellular phone conversation, base unit 20 may incorporate an antenna to allow reception of the cellular phone signals, or alternatively, a hard-wired connection to the cellular phone itself. The user may control these capabilities by pressing or otherwise accessing one or more of the control buttons 28, through voice activation, through steering wheel controls or through a remote control.

In addition to permanent storage of audio signals in physical memory, the audio system 10 may utilize temporary memory space as a method for increasing playback functionality. The base unit memory 26 may be used to continuously buffer input audio signals and offer pause, rewind, fast forward and replay functions to live radio broadcast.

FIG. 6 shows a process wherein the audio system 10 can be used as a digital radio recorder, according to an exemplary embodiment. A media service provider 50 may offer AM, FM, or satellite radio broadcast master programming information. The user may access this information using the command unit 51. The command unit 51 may be a personal computer or a network source. The user can determine which program to record by selecting the desired input. The list of programs to record with frequency, date and time information can constitute a master recording plan.

A connection may be established between the command unit and the digital media player 30 via a cable or other connection means such as a wireless connection during which the master recording plan may be transferred into the digital media player memory 32.

Each time the digital media player docks in the base unit 20, the base unit may check if an update to the master recording plan is available. The base unit 20 may download the plan from the digital media player's memory 32 and store the plan in its own memory 26.

At the time a recording is scheduled, the base unit 20 can tune to the desired band and frequency, convert the data stream into a digital audio format and, depending on the user's choice, save it in the digital media player's memory 32 if the digital media player is docked in the base unit 20, or in a removable physical state memory device 60.

Exemplary embodiments of the present invention have been illustrated and described. It should be noted that alternatives exist for the functions and specific components of the present invention. It should also be noted that the figures are not drawn to scale and are approximations of an exemplary embodiment. For example, corners may be rounded in an exemplary embodiment, rather than straight as depicted, as long as the general form and function of each element is preserved. Similarly, more significant changes in configuration and form are also possible and intended to be within the scope of the system taught herein. It will be understood, that variations in form and detail may be made to the invention without deviating from the spirit and scope of the invention, as defined by the following claims.

I claim:

1. An audio system with a portable digital media player interface, the audio system comprising:
a base unit having an internal bay into which a portable digital media player with a power supply is introduced in a set direction of introduction and ejection;
an audio processing unit that accepts at least one audio data input and outputs at least one amplified analog audio signal;
a first control panel that permits a user to adjust the audio input and output properties of the audio processing unit; and
a digital media player interface located within the base unit that permits audio data to be transferred from the portable digital media player to the audio processing unit.

2. The audio system of claim 1 wherein the base unit has a front panel with a slot through which the digital media player is introduced into the internal bay of the base unit.

3. The audio system of claim 2 further comprising a faceplate that covers the front panel and is attached to the front panel with a hinged attachment allowing the faceplate to fold away from the front panel and allow access to the slot in the front panel.

4. The audio system of claim 3 wherein the faceplate is detachable from the front panel.

5. The audio system of claim 3 wherein the first control panel is located on the faceplate.

6. The audio system of claim 1 further comprising a second control panel that operates remotely to communicate with the audio processing unit and adjust the audio input and output properties of the audio processing unit.

7. The audio system of claim 6 wherein the audio system is housed in an automobile having a steering wheel and the second control panel is located on the steering wheel of the automobile.

8. The audio system of claim 1 further comprising a transfer mechanism that inserts the music player into and ejects the music player out of the base unit automatically.

9. The audio system of claim 1 wherein the power supply of the portable digital media player is rechargeable.

10. The audio system of claim 9 further comprising an adapter for powering the digital media player and recharging the power supply of the digital media player.

11. The audio system of claim 1 wherein the digital media player interface is an electrical contact interface that allows communication between the digital media player and the audio processing unit through a wired connection.

12. The audio system of claim 1 wherein the digital media player interface is a wireless interface that allows communication between the digital media player and the audio processing unit through a wireless connection.

13. The audio system of claim 1 wherein the audio data transferred from the portable digital media player to the audio processing unit is in an analog format.

14. The audio system of claim 1 wherein the audio data transferred from the portable digital media player to the audio processing unit is in a digital format.

15. The audio system of claim 1 wherein the digital media player interface permits the user to control the functionality of the digital media player through the first control panel.

16. The audio system of claim 15 further comprising means for controlling the functionality of the digital media player through a digital media player interface and using the first control panel.

17. The audio system of claim 1 further comprising:
a memory that outputs stored encoded audio data to the audio processing unit; and
means for converting analog audio inputs to encoded audio data and storing said encoded audio data in the memory.

18. The audio system of claim 17 wherein the digital media interface also permits audio data to be transferred from the audio processing unit to the portable digital media player.

19. The audio system of claim 18 further comprising a microphone, wherein said means for converting analog audio inputs to encoded audio data and said digital media player interface permits recordings made through the microphone to be digitally transferred to the portable digital media player.

20. The audio system of claim 19 wherein the data memory and the instruction memory comprise a single memory unit.

21. The audio system of claim 1, further comprising a slot frame located within the internal bay that, when the digital media player is manually introduced into the base unit, translates the digital media player to a position that allows the digital media player and the digital media player interface to communicate.

22. A base unit for an audio system, comprising:
an internal bay configured to accept a portable digital media player with a power supply in a set direction of introduction and ejection; and
a slot frame located within the internal bay that, when the digital media player is manually introduced into the base unit, translates the digital media player to a position that allows the digital media player and the digital media player interface to communicate.

23. An audio system configured to accept a portable digital media player having a memory into an internal bay, the audio system comprising:
a base unit having an internal bay into which a portable digital media player is introduced in a set direction of introduction and ejection;
an audio processing unit that accepts at least one audio data input and outputs at least one amplified analog audio signal;
a control panel that permits a user to adjust the audio input and output properties of the audio processing unit;
a digital media player interface located within the base unit that permits audio data to be transferred from the portable digital media player to the audio processing unit;
a memory unit that outputs stored encoded audio data to the audio processing unit; and
means for converting analog audio inputs to encoded audio data and storing said encoded audio data in the memory unit.

24. The audio system of claim 23 further comprising means for storing the encoded audio data from the memory unit in the digital media player memory.
